(19) United States
(12) Patent Application Publication
(10) Pub. No.: US 2015/0361261 A1
(43) Pub. Date: Dec. 17, 2015

(54) RESIN COMPOSITION AND RESIN MOLDED ARTICLE

(71) Applicant: FUJI XEROX CO., LTD., Tokyo (JP)

(72) Inventor: Akira IMADA, Kanagawa (JP)

(73) Assignee: FUJI XEROX CO., LTD., Tokyo (JP)

(21) Appl. No.: 14/518,525

(22) Filed: Oct. 20, 2014

(30) Foreign Application Priority Data
Jun. 11, 2014 (JP) 2014-120590

(51) Int. Cl. C08L 69/00

(52) U.S. Cl. CPC C08L 69/00; C08L 2205/035

(57) ABSTRACT

A resin composition includes an aromatic polycarbonate, a styrene-based polymer, a polylactic acid resin, and an acrylic block copolymer that includes a polymer block containing a constitutional unit derived from an acrylic acid ester and a polymer block containing a constitutional unit derived from a methacrylic acid ester.

### CROSS-REFERENCE TO RELATED APPLICATIONS

This application is based on and claims priority under 35 USC 119 from Japanese Patent Application No. 2014-120590 filed Jun. 11, 2014.

### BACKGROUND

1. Technical Field

The present invention relates to a resin composition and a resin molded article.

2. Related Art

In the related art, various resin compositions are provided and are used for various applications. For example, these resin compositions are used in resin molded articles such as various components and cases of home electronics and automobiles or are used in resin molded articles such as cases of business machines and electric and electronic apparatuses.

In addition, recently, techniques in which a biodegradable resin having a small load on the environment is mixed as a resin material have been studied from the viewpoint of environmental protection. Among these techniques, a polylactic acid resin which is a plant-derived material has attracted attention. In order to improve mechanical properties and the like of a resin molded article which is obtained from a resin composition containing such a polylactic acid resin, a resin composition in which various resins are mixed with a polylactic acid resin has been studied.

### SUMMARY

According to an aspect of the invention, there is provided a resin composition including:

an aromatic polycarbonate;

a styrene-based polymer;

a polylactic acid resin; and

an acrylic block copolymer that includes a polymer block containing a constitutional unit derived from an acrylic acid ester and a polymer block containing a constitutional unit derived from a methacrylic acid ester.

### DETAILED DESCRIPTION

Exemplary embodiments of the invention will be described below. The exemplary embodiments are merely examples of the invention and do not limit the invention.

### Resin Composition

A resin composition according to an exemplary embodiment of the invention includes: an aromatic polycarbonate; a styrene-based polymer; a polylactic acid resin; and an acrylic block copolymer that includes a polymer block containing a constitutional unit derived from an acrylic acid ester and a polymer block containing a constitutional unit derived from a methacrylic acid ester.

In the related art, in consideration of environmental protection, a technique in which a resin composition obtained by mixing a polylactic acid resin, which is a biodegradable resin, with a petroleum-derived resin is used as a material of a resin molded article is known. However, in a resin composition containing a polylactic acid resin, an aromatic polycarbonate (petroleum-derived resin), and a styrene-based polymer (petroleum-derived resin), the polylactic acid resin is likely to be unevenly distributed in the resin composition. Therefore, the impact resistance and the like of a resin molded article obtained from this resin composition may be poorer, as compared to a resin composition containing an aromatic polycarbonate and a styrene-based polymer which do not contain a polylactic acid.

Here, it is considered that the acrylic block copolymer (hereinafter, simply referred to as “acrylic block copolymer”) used in the exemplary embodiment that includes a polymer block containing a constitutional unit derived from an acrylic acid ester and a polymer block containing a constitutional unit derived from a methacrylic acid ester is compatible mainly with a polylactic acid resin and functions as a thermoplastic elastomer which is softened and exhibits fluidity when being heated and returns to a rubber elastic member when being cooled. Therefore, it is considered that, by mixing the acrylic block copolymer with a mixed resin containing an aromatic polycarbonate, a styrene-based polymer, and a polylactic acid resin, the acrylic block copolymer and the polylactic acid resin are dispersed together in the resin composition, thereby preventing the uneven distribution of the polylactic acid resin. In addition, it is considered that the acrylic block copolymer is present in a resin molded article obtained from the resin composition in a state of being dispersed therein as a thermoplastic elastomer. Therefore, regarding the resin composition according to the exemplary embodiment containing an aromatic polycarbonate, a styrene-based polymer, a polylactic acid resin, and the acrylic block copolymer, the impact resistance and tensile fracture elongation of a resin molded article obtained from the resin composition may be improved, and the appearance of the obtained resin molded article may be better, as compared to a resin composition containing an aromatic polycarbonate, a styrene-based polymer, and a polylactic acid resin.

In addition, in the acrylic block copolymer that includes a polymer block containing a constitutional unit derived from an acrylic acid ester and a polymer block containing a constitutional unit derived from a methacrylic acid ester, fluidity or elasticity is higher than that of an acrylic acid ester polymer or a methacrylic acid ester polymer. Therefore, it is considered that, if composition ratios of resin compositions are the same, regarding the resin composition according to the exemplary embodiment containing an aromatic polycarbonate, a styrene-based polymer, a polylactic acid resin, and the acrylic block copolymer, the impact resistance and tensile fracture elongation of a resin molded article obtained from the resin composition are improved, and the appearance of the obtained resin molded article is better, as compared to a resin composition containing an aromatic polycarbonate, a styrene-based polymer, a polylactic acid resin, and an acrylic acid ester polymer or a methacrylic acid ester polymer.

Hereinafter, each component of the resin composition according to the exemplary embodiment will be described.

### Aromatic Polycarbonate

The aromatic polycarbonate is not particularly limited as long as it is a polycarbonate having an aromatic group, and examples thereof include polycarbonates of bisphenol A type, Z type, S type, MIBK type, AP type, and TP type, biphenyl type, and hydrogenated bisphenol A type.

The aromatic polycarbonate is prepared by, for example, a reaction between a divalent phenol and a carbonate precursor.

Examples of the divalent phenol include 2,2-bis(4-hydroxyphenyl)propane [bisphenol A], bis[4-hydroxyphenyl]methane, 1,1-bis[4-hydroxyphenyl]ethane, 2,2-bis[4-hydroxy-3,5-dimethylphenyl)propane, bis[4-hydroxyphenyl]cycloalkane, bis[4-hydroxyphenyl]oxide, bis[4-hydroxyphenyl]sulfide, bis[4-hydroxyphenyl]sulfone, bis[4-hydroxyphenyl]sulfoxide, bis[4-hydroxyphenyl]ether, and bis[4-hydroxyphenyl]ketone.

Examples of the carbonate precursor include carbonyl halide, carbonyl ester, and haloformate, and specific examples thereof include phosgene, dihaloformate of divalent phenol, diphenyl carbonate, dimethyl carbonate, and diethyl carbonate.

A molecular weight, for example, a weight average molecular weight of the aromatic polycarbonate is preferably from 10,000 to 100,000 and more preferably from 15,000 to 50,000. When the weight average molecular weight of the aromatic polycarbonate is less than 10,000, the fluidity of a resin composition is excessive, and the workability of a resin molded article may deteriorate. When the weight average molecular weight of the aromatic polycarbonate is more than 100,000, the fluidity of a resin composition deteriorates, and the workability of a resin molded article may deteriorate.

The weight average molecular weight is measured by gel permeation chromatography (GPC). In the measurement of the molecular weight by GPC, GPC HLC-8120 (manufactured by Tosoh Corporation) is used as a measuring device, TSKgel Super HM-M (15 cm; manufactured by Tosoh Corporation) is used as a column, and THF is used as a solvent. The weight average molecular weight is calculated using a molecular weight calibration curve obtained from the measurement result using monodisperse polystyrene standard samples. Hereinafter, regarding the measurement of the weight average molecular weight, the same shall be applied.

The content of the aromatic polycarbonate according to the exemplary embodiment is preferably from 30% by weight to 90% by weight and more preferably from 40% by weight to 80% by weight with respect to the total weight of the resin composition. When the content of the aromatic polycarbonate is less than 30% by weight or more than 90% by weight with respect to the total weight of the resin composition, the appearance of the resin molded article may be poor.

### Styrene-Based Polymer

The styrene-based polymer is not particularly limited as long as it is a polymer containing a constitutional unit derived from styrene. For example, a homopolymer of styrene may be used or a copolymer of styrene and a compound having a carbon-carbon double bond which is to be copolymerized with styrene.

Examples of the compound having a carbon-carbon double bond which is to be copolymerized with styrene include (meth)acrylic acids such as acrylic acid and methacrylic acid; (meth)acrylic acid alkyl esters such as methyl acrylate, butyl acrylate, propyl acrylate, methyl methacrylate, ethyl methacrylate, propyl methacrylate, and butyl methacrylate; unsaturated nitriles such as methacrylonitrile, ethacrylonitrile, and phenylacrylonitrile; dienes such as butadiene and isoprene; and aromatic vinyl compounds other than styrene.

Examples of the styrene-based polymer include an acrylonitrile-styrene copolymer (AS resin), an acrylonitrile-butadiene-styrene copolymer (ABS resin), an acrylonitrile-ethylene-styrene copolymer (AES resin), a methyl methacrylate-styrene copolymer (MS resin), and a methyl methacrylate-butadiene-styrene copolymer (MBS resin). From the viewpoints of heat resistance and impact resistance, an acrylonitrile-butadiene-styrene copolymer (ABS resin) or the like is preferable.

A molecular weight, for example, a weight average molecular weight of the styrene-based polymer is preferably from 1,000 to 1,000,000 and more preferably from 5,000 to 500,000. When the weight average molecular weight of the styrene-based polymer is less than 1,000, the fluidity of a resin composition is excessive, and the workability of a resin molded article may deteriorate. When the weight average molecular weight of the styrene-based polymer is more than 1,000,000, the fluidity of a resin composition deteriorates, and the workability of a resin molded article may deteriorate.

The content of the styrene-based polymer according to the exemplary embodiment is preferably from 5% by weight to 40% by weight and more preferably from 10% by weight to 30% by weight with respect to the total weight of the resin composition. When the content of the styrene-based polymer is less than 5% by weight or more than 40% by weight with respect to the total weight of the resin composition, the appearance of the resin molded article may be poor.

### Polylactic Acid Resin

The polylactic acid resin is not particularly limited as long as it is a condensate of lactic acid. For example, a poly-L-lactic acid resin, a poly-D-lactic acid resin, or a mixture thereof (for example, a stereo complex type polylactic acid resin which is a mixture of a poly-L-lactic acid resin and a poly-D-lactic acid resin) may be used. In addition, as the polylactic acid resin, a synthetic resin or a commercially available resin may be used. Examples of the commercially available resin include “TERRAMAC TE4000”, “TERRAMAC TE2000”, and “TERRAMAC TE7000”, (manufactured by UNITIKA Ltd.); “LACEA H100” (manufactured by Mitsui Chemicals Inc); and “INGEO 3001D” (manufactured by NatureWorks LLC).

A molecular weight, for example, a weight average molecular weight of the polylactic acid resin is preferably from 8,000 to 200,000 and more preferably from 15,000 to 120,000. When the weight average molecular weight of the polylactic acid resin is less than 8,000 or more than 200,000, the heat resistance of a resin molded article obtained from the resin composition may deteriorate.

The content of the polylactic acid resin according to the exemplary embodiment is preferably from 5% by weight to 50% by weight and more preferably from 10% by weight to 40% by weight with respect to the total weight of the resin composition. When the content of the polylactic acid resin is less than 5% by weight with respect to the total weight of the resin composition, the biodegradability of a resin molded article obtained from the resin composition may deteriorate. When the content of the polylactic acid resin is more than 50% by weight with respect to the total weight of the resin composition, the appearance of a resin molded article obtained from the resin composition may be poor.

The acrylic block copolymer includes a polymer block containing a constitutional unit derived from an acrylic acid ester and a polymer block containing a constitutional unit derived from a methacrylic acid ester.

Polymer Block Containing Constitutional Unit Derived from Acrylic Acid Ester

Examples of the constitutional unit derived from an acrylic acid ester include constitutional units derived from monomers such as methyl acrylate, ethyl acrylate, propyl acrylate, butyl acrylate, isobutyl acrylate, n-octyl acrylate, dodecyl acrylate, 2-ethylhexyl acrylate, stearyl acrylate, phenyl acrylate, and dimethyl aminoethyl acrylate. Among these, one kind or a combination of two or more kinds may be used.

The polymer block containing a constitutional unit derived from an acrylic acid ester is obtained by, for example, a polymerization reaction of the above-described monomers. A molecular weight, for example, a weight average molecular weight of the polymer block containing a constitutional unit derived from an acrylic acid ester is preferably from 6,000 to 1,000,000 and more preferably from 10,000 to 800,000. When the weight average molecular weight of the polymer block containing a constitutional unit derived from an acrylic acid ester is less than 6,000, impact resistance may deteriorate. When the weight average molecular weight of the polymer block containing a constitutional unit derived from an acrylic acid ester is more than 1,000,000, the fluidity of the acrylic block copolymer may deteriorate.

The polymer block containing a constitutional unit derived from an acrylic acid ester may further include another constitutional unit in addition to the constitutional unit derived from an acrylic acid ester. Examples of another constitutional unit include other monomers such as glycidyl acrylate, allyl acrylate, methacrylic acid ester, methacrylic acid, acrylic acid, an aromatic vinyl compound, acrylonitrile, methacrylonitrile, and olefin.

The content of the polymer block containing a constitutional unit derived from an acrylic acid ester in the acrylic block copolymer is preferably from 30% by weight to 90% by weight and more preferably from 40% by weight to 80% by weight. When the content of the polymer block containing a constitutional unit derived from an acrylic acid ester is in the above-described range, the appearance of a resin molded article obtained from the resin composition is much better as compared to a case of being out of the above-described range.

Polymer Block Containing Constitutional Unit Derived from Methacrylic Acid Ester

Examples of the constitutional unit derived from a methacrylic acid ester include constitutional units derived from monomers such as methyl methacrylate, ethyl methacrylate, propyl methacrylate, butyl methacrylate, hexyl methacrylate, cyclohexyl methacrylate, octyl methacrylate, nonyl methacrylate, octadecyl methacrylate, dodecyl methacrylate, and 2-ethylhexyl methacrylate. Among these, one kind or a combination of two or more kinds may be used.

The polymer block containing a constitutional unit derived from a methacrylic acid ester is obtained by, for example, a polymerization reaction of the above-described monomers. A molecular weight, for example, a weight average molecular weight of the polymer block containing a constitutional unit derived from a methacrylic acid ester is preferably from 1,000 to 1,000,000 and more preferably from 2,000 to 750,000. When the weight average molecular weight of the polymer block containing a constitutional unit derived from a methacrylic acid ester is less than 1,000, the dispersibility in a matrix resin may deteriorate. When the weight average molecular weight of the polymer block containing a constitutional unit derived from a methacrylic acid ester is more than 1,000,000, the fluidity of the acrylic block copolymer may deteriorate.

The polymer block containing a constitutional unit derived from a methacrylic acid ester may further include another constitutional unit in addition to the constitutional unit derived from a methacrylic acid ester. Examples of another constitutional unit include other monomers such as acrylic acid ester, methacrylic acid, acrylic acid, an aromatic vinyl compound, acrylonitrile, methacrylonitrile, and olefin.

The content of the polymer block containing a constitutional unit derived from a methacrylic acid ester in the acrylic block copolymer is preferably from 15% by weight to 70% by weight and more preferably from 20% by weight to 60% by weight. It is considered that, when the content of the polymer block containing a constitutional unit derived from a methacrylic acid ester is in the above-described range, the compatibility with a matrix resin is improved as compared to a case of being out of the above-described range.

As long as the acrylic block copolymer according to the exemplary embodiment is a block copolymer that includes a polymer block containing a constitutional unit derived from an acrylic acid ester and a polymer block containing a constitutional unit derived from a methacrylic acid ester, any linking type of constitutional blocks thereof may be adopted. That is, when the polymer block containing a constitutional unit derived from an acrylic acid ester is represented by A and the polymer block containing a constitutional unit derived from a methacrylic acid ester is represented by B, examples of the acrylic block copolymer include an AB type diblock copolymer, an ABA type triblock copolymer, a BAB type triblock copolymer, an (AB)n type multiblock copolymer, an (AB)nA type multiblock copolymer, a B(AB)n type multiblock copolymer, and a block-graft copolymer in which A and/or B is grafted to a side chain of a block copolymer such as an ABA type. Among these, from the viewpoint of impact resistance, tensile fracture elongation, or appearance, it is preferable that the acrylic block copolymer be a triblock copolymer (BAB type triblock copolymer) in which the polymer block containing a constitutional unit derived from a methacrylic acid ester is bonded to both terminals of the polymer block containing a constitutional unit derived from an acrylic acid ester. By using the BAB type triblock copolymer, the impact resistance and tensile fracture elongation of a resin molded article obtained from the resin composition is further improved, and the appearance thereof is further improved as compared to a case where an AB type diblock copolymer is used.

Specific examples of the acrylic block copolymer include a diblock copolymer containing a methyl methacrylate polymer block and an n-butyl acrylate polymer block and a triblock copolymer in which a methyl methacrylate polymer block is bonded to both terminals of an n-butyl acrylate polymer block.

A molecular weight, for example, a weight average molecular weight of the acrylic block copolymer is preferably from 1,000 to 1,000,000 and more preferably from 2,000 to 500,000. When the weight average molecular weight of the acrylic block copolymer is less than 1,000 or more than 1,000,000, the fluidity in the resin composition may deteriorate, and the impact resistance and tensile fracture elongation thereof may deteriorate as compared to a case of being in the above-described range.

The content of the acrylic block copolymer is, for example, preferably from 1.0% by weight to 10% by weight and more preferably from 1.5% by weight to 8% by weight with respect to 100 parts by weight of a total weight of the aromatic polycarbonate, the styrene-based polymer, and the polylactic acid resin. It is considered that: when the content of the acrylic block copolymer is in the above-described range, the appearance of a resin molded article obtained from the resin composition is further improved as compared to a case where the content is less than 1% by weight or more than 10% by weight.

As a method of preparing the acrylic block copolymer, for example, a method of living polymerization of monomers constituting the respective blocks may be used. Examples of this living polymerization method include: a method in which anionic polymerization is performed in the presence of a mineral acid salt such as a salt of alkali metal or alkali earth metal by using an organic alkali metal compound as a polymerization initiator; a method in which anionic polymerization is performed in the presence of an organic aluminum compound by using an organic alkali metal compound as a polymerization initiator; a method in which polymerization is performed by using an organic rare earth metal complex as a polymerization initiator; and a method in which radical polymerization is performed in the presence of a copper compound by using an α-halogenated ester compound as a polymerization initiator. A radical polymerization method is preferable as a method of preparing the triblock copolymer (BAB type triblock copolymer) in which the polymer block containing a constitutional unit derived from a methacrylic acid ester is bonded to both terminals of the polymer block containing a constitutional unit derived from an acrylic acid ester.

As the acrylic block copolymer, a commercially available copolymer may also be used. Examples of the commercially available copolymer include “LA2140e (trade name)”, “LA2250 (trade name)”, “LA4285 (trade name)”, and “LA1114 (trade name)” (manufactured by Kuraray Co., Ltd.).

### Other Components

The resin composition according to the exemplary embodiment may further contain other components within a range where the impact resistance, tensile fracture elongation, and appearance of a resin molded article obtained from the resin composition are not impaired. Examples of other components include a flame retardant, a hydrolysis inhibitor, an antioxidant, and a filler.

Examples of the flame retardant include phosphorus-based, silicone-based, nitrogen-based, and inorganic hydroxide-based flame retardants. Among these, a phosphorus-based flame retardant is preferable from the viewpoint of flame retardance. As the flame retardant, a synthetic flame retardant or a commercially available flame retardant may be used. Examples of a commercially available phosphorus-based flame retardant include “CR-741” (manufactured by Daihachi Chemical Industry Co., Ltd.), “AP422” (manufactured by Clariant), and “Nova Excell 140” (manufactured by Rin Kagaku Kogyo Co., Ltd.). Examples of a commercially available silicone-based flame retardant include “DC4-7081” (manufactured by Dow Corning Toray Silicone Co., Ltd.). Examples of a commercially available nitrogen-based flame retardant include “APINON 901” (manufactured by Sanwa Chemical Co., Ltd.). Examples of a commercially available inorganic hydroxide-based flame retardant include “MGZ 300” (manufactured by Sakai Chemical Industry Co., Ltd.).

Examples of the hydrolysis inhibitor include carbodiimide compounds and oxazoline compounds. Examples of the carbodiimide compounds include dicyclohexyl carbodiimide, diisopropyl carbodiimide, dimethyl carbodiimide, diisobutyl carbodiimide, dioctyl carbodiimide, diphenyl carbodiimide, and naphthyl carbodiimide.

Examples of the antioxidant include phenol-based, amine-based, phosphorus-based, sulfur-based, hydroquinone-based, and quinoline-based antioxidants.

Examples of the filler include clays such as kaolin, bentonite, kibushi clay, and gairome clay, talc, mica, and montmorillonite.

### Resin Molded Article

A resin molded article according to an exemplary embodiment of the present invention includes the above-described resin composition according to the exemplary embodiment. For example, the resin molded article according to the exemplary embodiment is obtained by molding the above-described resin composition according to the exemplary embodiment using a molding method such as injection molding, extrusion molding, blow molding, or hot press molding. In the exemplary embodiment, from the viewpoints of dispersibility of each component in the resin molded article and the like, it is preferable that the resin molded article be obtained by molding the resin composition according to the exemplary embodiment by injection molding.

The injection molding is performed using a commercially available machine such as “NEX150” (manufactured by Nissei Plastic Industrial Co., Ltd.), “NEX70000” (manufactured by Nissei Plastic Industrial Co., Ltd.), or “SE50D” (manufactured by Toshiba Machine Co., Ltd.). At this time, a cylinder temperature is preferably from 170° C. to 280° C. from the viewpoints of the compatibility of the polylactic acid resin, the styrene-based resin, and the aromatic polycarbonate resin. In addition, a die temperature is preferably from 30° C. to 120° C. from the viewpoints of productivity and the like.

The resin molded article according to the exemplary embodiment is preferably used in applications such as electronic and electric apparatuses, home electronics, containers, and automobile interior materials. Specifically, the resin molded article according to the exemplary embodiment is used in various cases and components of home electronics and electronic and electric apparatuses, for example, in wrapping films, storage cases of CD-ROM or DVD, tableware, food trays, beverage bottles, and wrapping materials for chemicals. In particular, the resin molded article according to the exemplary embodiment is preferably used in components of electronic and electric apparatuses. For components of electronic and electric apparatuses, high impact resistance and tensile fracture elongation and a good appearance are required. In the resin molded article according to the exemplary embodiment obtained from a resin composition containing an aromatic polycarbonate, a styrene-based polymer, a polylactic acid resin, and an acrylic block copolymer that includes a polymer block containing a constitutional unit derived from an acrylic acid ester and a polymer block containing a constitutional unit derived from a methacrylic acid ester, the impact resistance and tensile fracture elongation are improved, and the appearance is better as compared to a resin molded article obtained from a resin composition containing an aromatic polycarbonate, a styrene-based polymer, and a polylactic acid resin.

### EXAMPLES

Hereinafter, the invention will be described in more detail using Examples and Comparative Examples but is not limited to these Examples.

### Acrylic Block Copolymer A-1

Acrylic block copolymer A-1 is “LA2250” (manufactured by Kuraray Co., Ltd.) and a triblock copolymer of PMMA (methyl methacrylate polymer) block-PnBA (n-butyl acrylate polymer) block-PMMA block. In Acrylic block copolymer A-1, a weight average molecular weight (Mw) is 60,300, a molecular weight distribution (Mw/Mn) is 1.14, and a ratio of the respective polymer blocks is PMMA (16% by weight)-PnBA (68% by weight)-PMMA (16% by weight).

### Acrylic Block Copolymer A-2

Acrylic block copolymer A-2 is “LA2140e” (manufactured by Kuraray Co., Ltd.) and a triblock copolymer of PMMA block-PnBA block-PMMA block. In Acrylic block copolymer A-2, a weight average molecular weight (Mw) is 79,800, a molecular weight distribution (Mw/Mn) is 1.07, and a ratio of the respective polymer blocks is PMMA (12% by weight)-PnBA (76% by weight)-PMMA (12% by weight).

### Acrylic Block Copolymer A-3

Acrylic block copolymer A-3 is a triblock copolymer of PMMA block-PnBA block-PMMA block. In Acrylic block copolymer A-3, a weight average molecular weight (Mw) is 40,300, a molecular weight distribution (Mw/Mn) is 1.21, and a ratio of the respective polymer blocks is PMMA (35% by weight)-PnBA (30% by weight)-PMMA (35% by weight).

### Acrylic Block Copolymer A-4

Acrylic block copolymer A-4 is a triblock copolymer of PMMA block-PnBA block-PMMA block. In Acrylic block copolymer A-4, a weight average molecular weight (Mw) is 36,100, a molecular weight distribution (Mw/Mn) is 1.31, and a ratio of the respective polymer blocks is PMMA (40% by weight)-PnBA (20% by weight)-PMMA (40% by weight).

### Acrylic Block Copolymer A-5

Acrylic block copolymer A-5 is a triblock copolymer of PMMA block-PnBA block-PMMA block. In Acrylic block copolymer A-5, a weight average molecular weight (Mw) is 90,400, a molecular weight distribution (Mw/Mn) is 1.31, and a ratio of the respective polymer blocks is PMMA (5% by weight)-PnBA (90% by weight)-PMMA (5% by weight).

### Acrylic Block Copolymer A-6

Acrylic block copolymer A-6 is a diblock copolymer of PMMA block-PnBA block. In Acrylic block copolymer A-6, a weight average molecular weight (Mw) is 20,000, a molecular weight distribution (Mw/Mn) is 1.76, and a ratio of the respective polymer blocks is PMMA (50% by weight)-PnBA (50% by weight).

Acrylic Block Copolymer A-7

Acrylic block copolymer A-7 is a triblock copolymer of PMMA block-PnBA block-PMMA block. In Acrylic block copolymer A-7, a weight average molecular weight (Mw) is 80,600, a molecular weight distribution (Mw/Mn) is 1.12, and a ratio of the respective polymer blocks is PMMA (10% by weight)-PnBA (80% by weight)-PMMA (10% by weight).

### Acrylic Block Copolymer A-8

Acrylic block copolymer A-8 is a triblock copolymer of PMMA block-poly(2-ethylhexyl acrylate) block-PMMA block. In Acrylic block copolymer A-8, a weight average molecular weight (Mw) is 95,000, a molecular weight distribution (Mw/Mn) is 1.23, and a ratio of the respective polymer blocks is PMMA (10% by weight)-poly(2-ethylhexyl acrylate) (80% by weight)-PMMA (10% by weight).

### Comparative Polymer B-1

Comparative polymer B-1 is “METABLEN P-530A” (manufactured by Mitsubishi Rayon Co., Ltd.) and a homopolymer of PMMA. In Comparative polymer B-1, a weight average molecular weight (Mw) is 3,600,000 and a molecular weight distribution (Mw/Mn) is 1.01.

### Comparative Polymer B-2

Comparative polymer B-2 is “N3508” (manufactured by Otsuka Chemical Co., Ltd.) and a homopolymer of PnBA. In Comparative polymer B-2, a weight average molecular weight (Mw) is 27,800, and a molecular weight distribution (Mw/Mn) is 1.01.

### Comparative Polymer B-3

Comparative Polymer B-3 is a styrene-based block copolymer of “MA-001” (manufactured by Kuraray Co., Ltd.) and is a maleic anhydride-modified product of a triblock copolymer of PSt (polystyrene polymer) block-EEP (ethyl 3-ethoxypropionate polymer) block-PSt block. In Comparative polymer B-3, a weight average molecular weight (Mw) is 101,000, a molecular weight distribution (Mw/Mn) is 1.10, an addition amount of maleic anhydride is 1.2% by weight, an a ratio of the respective polymer blocks is PSt (14.8% by weight)-EEP (69.2% by weight)-PSt (14.8% by weight).

### Comparative Polymer B-4: Styrene-Based Block Copolymer

Comparative polymer B-4 is a styrene-based block copolymer of “M1913” (manufactured by Asahi Kasei Chemicals Corporation) and is a maleic anhydride-modified product of a triblock copolymer of PSt block-EB (hydrogenated butadiene-butylene polymer) block-PSt block. In Comparative polymer B-4, a weight average molecular weight (Mw) is 94,900, a molecular weight distribution (Mw/Mn) is 1.62, an acid value (CH₃ONa) is 10 mg/g, and a ratio of the respective polymer blocks is PSt (15% by weight)-EB (70% by weight)-PSt (15% by weight).

### Example 1

With a composition shown in Table 1 (all of which are represented by part(s) by weight), 30 parts by weight of polylactic acid resin (trade name “Ingeo 4032D”, manufactured by NatureWorks LLC, weight average molecular weight: 150,000), 55 parts by weight of aromatic polycarbonate resin (trade name “IUPILON S2000”, manufactured by Mitsubishi Engineering-Plastics Corporation, weight average molecular weight: 39,000), 15 parts by weight of acrylonitrile-butadiene-styrene resin (trade name “TOYOLAC 700”, manufactured by Toray Industries Inc.) as the styrene-based polymer, 5 parts by weight of Acrylic block copolymer A-1, and 1 part by weight of hydrolysis inhibitor (trade name “HMV-8CA”, manufactured by Nisshinbo Industries, Inc.) are mixed with each other, and the obtained mixture is supplied to a hopper of a vent-equipped twin-screw extruder (TEX-30a, manufactured by The Japan Steel Works Ltd.), followed by melt-kneading extrusion under conditions of a cylinder temperature and a die temperature of 220° C., a screw rotation speed of 240 rpm, a vent suction degree of 100 MPa, and a discharge amount of 10 kg/h. The resin extruded from the twin screw extruder is cut into a pellet.

The obtained pellet-shaped resin composition is dried using a hot-air drying machine at 80° C. for 4 hours, followed by injection molding with an injection molding machine (trade name: “NEX500” manufactured by Toshiba Machine Co., Ltd.) at a cylinder temperature of 230° C. Heat and cool molding is performed in which the molded resin is cooled at a die temperature of 110° C. for 50 seconds and is rapidly cooled to 60° C. As a result, a predetermined resin molded article (test piece for evaluation) is obtained.

### Example 2

A predetermined resin molded article (test piece for evaluation) is obtained under the same conditions as Example 1, except that Acrylic block copolymer A-2 is used instead of Acrylic block copolymer A-1.

### Example 3

A predetermined resin molded article (test piece for evaluation) is obtained under the same conditions as Example 1, except that Acrylic block copolymer A-3 is used instead of Acrylic block copolymer A-1.

### Example 4

A predetermined resin molded article (test piece for evaluation) is obtained under the same conditions as Example 1, except that Acrylic block copolymer A-4 is used instead of Acrylic block copolymer A-1.

### Example 5

A predetermined resin molded article (test piece for evaluation) is obtained under the same conditions as Example 1, except that Acrylic block copolymer A-5 is used instead of Acrylic block copolymer A-1.

### Example 6

A predetermined resin molded article (test piece for evaluation) is obtained under the same conditions as Example 1, except that Acrylic block copolymer A-6 is used instead of Acrylic block copolymer A-1.

### Example 7

A predetermined resin molded article (test piece for evaluation) is obtained under the same conditions as Example 1, except that Acrylic block copolymer A-7 is used instead of Acrylic block copolymer A-1.

### Example 8

A predetermined resin molded article (test piece for evaluation) is obtained under the same conditions as Example 1, except that Acrylic block copolymer A-8 is used instead of Acrylic block copolymer A-1.

### Comparative Example 1

A predetermined resin molded article (test piece for evaluation) is obtained under the same conditions as Example 1, except that Comparative polymer B-1 is used instead of Acrylic block copolymer A-1.

### Comparative Example 2

A predetermined resin molded article (test piece for evaluation) is obtained under the same conditions as Example 1, except that Comparative polymer B-2 is used instead of Acrylic block copolymer A-1.

### Comparative Example 3

A predetermined resin molded article (test piece for evaluation) is obtained under the same conditions as Example 1, except that Comparative polymer B-3 is used instead of Acrylic block copolymer A-1.

### Comparative Example 4

A predetermined resin molded article (test piece for evaluation) is obtained under the same conditions as Example 1, except that Comparative polymer B-4 is used instead of Acrylic block copolymer A-1.

### Comparative Example 5

A predetermined resin molded article (test piece for evaluation) is obtained under the same conditions as Example 1, except that the acrylic block copolymer is not mixed and a resin composition containing a polylactic acid resin, an aromatic polycarbonate resin, and an acrylonitrile-butadiene-styrene resin is used.

### Evaluation and Test

Using the obtained test pieces for evaluation, the following evaluation and test are performed. Table 1 collectively shows the compositions (all of which are represented by part(s) by weight) of the resin compositions of Examples 1 to 8 and the results of the following evaluation and test thereof. In addition, Table 2 collectively shows the compositions (all of which are represented by part(s) by weight) of the resin compositions of Comparative Examples 1 to 5 and the results of the following evaluation and tests thereof.

### Evaluation of Appearance

A resin molded article which is a flat plate of 80 mm×120 mm×2 mm and whose center has an opening of 8 my) is used as a test piece, a surface thereof is observed by visual inspection, and a weld line, a flow mark, and pearly luster (that is, when brilliance is observed) are evaluated as follows on a scale of 1 to 5. Here, the weld line is a line which is formed opposite a mold gate portion when resin flows meet. In addition, the flow mark is a wavy convex-concave portion which appears from the opening of the test piece in a resin flowing direction. In all the appearance evaluations, when the score is 3 or higher (total score: 9 or higher), the appearance can be considered to be good.

### Weld Line

1: The length of the weld line on the surface of the test piece is 56 mm or longer

2: The length of the weld line on the surface of the test piece is from 30 mm to 56 mm

3: The length of the weld line on the surface of the test piece is from 10 mm to 30 mm

4: The length of the weld line on the surface of the test piece is 10 mm or less

5: No weld line is formed on the surface of the test piece

### Flow Mark

1: The number of flow marks on the surface of the test piece is 10 or more

2: The number of flow marks on the surface of the test piece is from 3 to less than 10

3: The number of flow marks on the surface of the test piece is 2

4: The number of flow marks on the surface of the test piece is 1

5: No flow mark is formed on the surface of the test piece

### Pearly Luster

1: No pearly luster is observed on the surface of the test piece

2: Weak pearly luster is observed on the surface of the test piece

3: Pearly luster is observed on the surface of the test piece

4: Strong pearly luster is observed on the surface of the test piece

5: Strongest pearly luster is observed on the surface of the test piece

### Test of Tensile Strength and Tensile Fracture Elongation

The tensile strength and tensile fracture elongation of the test piece is measured according to JIS K-7113. As a molded article, a JIS No. 1 test piece (thickness: 4 mm) obtained by injection molding is used. The higher the numerical value of the tensile strength, the higher the tensile strength. The higher the numerical value of the tensile fracture elongation, the higher the tensile fracture elongation.

### Test of Impact Resistance

A Charpy impact strength (unit: kJ/m²) of a notched ISO multi-purpose dumbbell test piece is measured in the MD direction according to JIS K 7111 using a digital impact tester (DG-5, manufactured by Toyo Seiki Seisaku-Sho Ltd.) under conditions of an elevation angle of 150 degrees, use of a hammer of 2.0 J, and the number of times of measurement n=10. The higher the numerical value of the Charpy impact strength, the higher the impact resistance.

### Test of Heat Resistance

In a state where a load (1.8 MPa) defined in a test method standard of ASTM D648 is applied to a test piece, the temperature of the test piece for evaluation is increased to measure a temperature (DTUL; Deflection Temperature Under Load) at which the size of deflection is a defined value. This temperature is evaluated as a heat resistance temperature.

TABLE 1

| | Composition | Example 1 | Example 2 | Example 3 | Example 4 | Example 5 | Example 6 | Example 7 | Example 8 |
|---|---|---|---|---|---|---|---|---|---|
| Resin | Polylactic Acid Resin | 30 | 30 | 30 | 30 | 30 | 30 | 30 | 30 |
| Composition | Aromatic | 55 | 55 | 55 | 55 | 55 | 55 | 55 | 55 |
| | Polycarbonate Resin | | | | | | | | |
| | ABS Resin | 15 | 15 | 15 | 15 | 15 | 15 | 15 | 15 |
| | Acrylic Block | 5 | | | | | | | |
| | Copolymer (A-1) | | | | | | | | |
| | Acrylic Block | | 5 | | | | | | |
| | Copolymer (A-2) | | | | | | | | |
| | Acrylic Block | | | 5 | | | | | |
| | Copolymer (A-3) | | | | | | | | |
| | Acrylic Block | | | | 5 | | | | |
| | Copolymer (A-4) | | | | | | | | |
| | Acrylic Block | | | | | 5 | | | |
| | Copolymer (A-5) | | | | | | | | |
| | Acrylic Block | | | | | | 5 | | |
| | Copolymer (A-6) | | | | | | | | |
| | Acrylic Block | | | | | | | 5 | |
| | Copolymer (A-7) | | | | | | | | |
| | Acrylic Block | | | | | | | | 5 |
| | Copolymer (A-8) | | | | | | | | |
| | Hydrolysis Inhibitor | 1 | 1 | 1 | 1 | 1 | 1 | 1 | 1 |
| Evaluation | | | | | | | | | |
| Result | | | | | | | | | |
| Appearance | Weld Line | 5 | 5 | 5 | 5 | 4 | 3 | 5 | 4 |
| | Flow Mark | 5 | 4 | 5 | 3 | 3 | 3 | 4 | 4 |
| | Pearly Luster | 5 | 5 | 5 | 5 | 5 | 3 | 4 | 4 |
| | Total Score | 15 | 14 | 15 | 13 | 12 | 9 | 13 | 12 |
| Heat | DTUL (1.8 MPa) | 91 | 90 | 93 | 92 | 89 | 84 | 89 | 86 |
| Resistance | | | | | | | | | |
| Mechanical | Tensile Strength | 55 | 54 | 57 | 56 | 53 | 52 | 54 | 51 |
| Properties | (MPa) | | | | | | | | |
| | Tensile Fracture | 12.3 | 13.5 | 10.5 | 8.5 | 13.2 | 7.4 | 13.0 | 8.6 |
| | Elongation (%) | | | | | | | | |
| | Charpy Impact | 23.5 | 24.5 | 16.8 | 14.5 | 22.1 | 9.0 | 21.0 | 19.0 |
| | Strength (kJ/m²) | | | | | | | | |

TABLE 2

| | | Comparative | Comparative | Comparative | Comparative | Comparative |
|---|---|---|---|---|---|---|
| | Composition | Example 1 | Example 2 | Example 3 | Example 4 | Example 5 |
| Resin | Polylactic Acid Resin | 30 | 30 | 30 | 30 | 30 |
| Composition | Aromatic | 55 | 50 | 55 | 55 | 55 |
| | Polycarbonate Resin | | | | | |
| | ABS Resin | 15 | 15 | 15 | 15 | 15 |
| | Comparative Polymer | 5 | | | | |
| | (B-1) | | | | | |
| | Comparative Polymer | | 5 | | | |
| | (B-2) | | | | | |
| | Comparative Polymer | | | 5 | | |
| | (B-3) | | | | | |
| | Comparative Polymer | | | | 5 | |
| | (B-4) | | | | | |
| | Hydrolysis Inhibitor | 1 | | 1 | 1 | 1 |
| Evaluation | | | | | | |
| Result | | | | | | |
| Appearance | Weld Line | 3 | 1 | 1 | 2 | 1 |
| | Flow Mark | 4 | 1 | 2 | 1 | 1 |
| | Pearly Luster | 4 | 2 | 1 | 1 | 1 |
| | Total Score | 11 | 4 | 4 | 4 | 3 |
| Heat | DTUL (1.8 MPa) | 88 | 84 | 84 | 83 | 83 |
| Resistance | | | | | | |
| Mechanical | Tensile Strength | 52 | 49 | 51 | 51 | 51 |
| Properties | (MPa) | | | | | |
| | Tensile Fracture | 4.2 | 2.4 | 3.8 | 3.4 | 2.4 |
| | Elongation (%) | | | | | |
| | Charpy Impact | 4.1 | 1.2 | 2.5 | 2.4 | 2.0 |
| | Strength (kJ/m²) | | | | | |

As shown in Tables 1 and 2, in the resin molded articles of Examples 1 to 8 obtained from the resin composition containing an aromatic polycarbonate, a styrene-based polymer, a polylactic acid resin, and an acrylic block copolymer that includes a PMMA block and a PnBA block, the scores in the evaluations of the weld line, the flow mark, and the pearly luster are respectively 3 or higher (total score: 9 or higher), the tensile fracture elongation is 7(%) or higher, and the impact resistance is 8 (kJ/m²) or higher. In addition, in the resin molded articles of Examples 1 to 8, the impact resistance and tensile fracture elongation are improved, and the appearance is better, as compared to the resin molded article of Comparative Example 5 obtained from the mixed resin containing an aromatic polycarbonate, a styrene-based polymer, and a polylactic acid resin. In addition, in the resin molded articles of Examples 1 to 8, the appearance is equivalent or higher, and the impact resistance and tensile fracture elongation are improved, as compared to the resin molded article of Comparative Example 1 obtained from the resin composition containing the above-described mixed resin and PMMA. Further, in the resin molded articles of Examples 1 to 8, the impact resistance, tensile fracture elongation, and appearance are improved, as compared to the resin molded articles of Comparative Example 2 to 4 obtained from the resin composition containing the above-described mixed resin and PnBA or a styrene-based block copolymer.

In addition, the resin molded articles of Examples 1 to 3 and 7 obtained from the resin composition in which the content of PnBA (polymer block containing a constitutional unit derived from an acrylic acid ester) in the acrylic block copolymer is 30% by weight to 80% by weight have a better appearance as compared to the resin molded articles of Examples 4 and 5 obtained from the resin composition in which the content of PnBA is less than 30% by weight or more than 80% by weight. In addition, in the resin molded articles of Examples 1 to 5 and 7 obtained from the resin composition containing a triblock copolymer of PMMA-PnBA-PMMA, the impact resistance and tensile fracture elongation are further improved and the appearance is much better as compared to the resin molded article of Example 6 obtained from the resin composition containing a diblock copolymer of PMMA-PnBA.

### Example 9

A predetermined resin molded article (test piece for evaluation) is obtained under the same conditions as Example 1, except that 50 parts by weight of polylactic acid resin, 40 parts by weight of aromatic polycarbonate resin, 10 parts by weight of acrylonitrile-butadiene-styrene resin, 5 parts by weight of Acrylic block copolymer A-1, and 1 part by weight of hydrolysis inhibitor are mixed.

### Example 10

A predetermined resin molded article (test piece for evaluation) is obtained under the same conditions as Example 1, except that 80 parts by weight of polylactic acid resin, 15 parts by weight of aromatic polycarbonate resin, 5 parts by weight of acrylonitrile-butadiene-styrene resin, 5 parts by weight of Acrylic block copolymer A-1, and 1 part by weight of hydrolysis inhibitor are mixed.

### Example 11

A predetermined resin molded article (test piece for evaluation) is obtained under the same conditions as Example 1, except that 10 parts by weight of polylactic acid resin, 70 parts by weight of aromatic polycarbonate resin, 20 parts by weight of acrylonitrile-butadiene-styrene resin, 5 parts by weight of Acrylic block copolymer A-1, and 1 part by weight of hydrolysis inhibitor are mixed.

### Comparative Example 6

A predetermined resin molded article (test piece for evaluation) is obtained under the same conditions as Example 9, except that Comparative polymer B-1 is used instead of Acrylic block copolymer A-1.

### Comparative Example 7

A predetermined resin molded article (test piece for evaluation) is obtained under the same conditions as Example 10, except that Comparative polymer B-1 is used instead of Acrylic block copolymer A-1.

### Comparative Example 8

A predetermined resin molded article (test piece for evaluation) is obtained under the same conditions as Example 11, except that Comparative polymer B-1 is used instead of Acrylic block copolymer A-1.

Using the obtained test pieces for evaluation, the same evaluation and test as Example 1 are performed. Table 3 collectively shows the compositions (all of which are represented by part(s) by weight) of the resin compositions of Examples 9 to 11 and Comparative Examples 6 to 8 and the results of the above-described evaluation and test thereof.

TABLE 3

| | | | | | Comparative | Comparative | Comparative |
|---|---|---|---|---|---|---|---|
| | Composition | Example 9 | Example 10 | Example 11 | Example 6 | Example 7 | Example 8 |
| Composition | Polylactic Acid | 50 | 80 | 10 | 50 | 80 | 10 |
| | Resin | | | | | | |
| | Aromatic | 40 | 15 | 70 | 40 | 15 | 70 |
| | Polycarbonate | | | | | | |
| | Resin | | | | | | |
| | ABS Resin | 10 | 5 | 20 | 10 | 5 | 20 |
| | Acrylic Block | 5 | 5 | 5 | | | |
| | Copolymer (A-1) | | | | | | |
| | Comparative | | | | 5 | 5 | 5 |
| | Polymer (B-1) | | | | | | |
| | Hydrolysis | 1 | 1 | 1 | 1 | 1 | 1 |
| | Inhibitor | | | | | | |
| Evaluation | | | | | | | |
| Result | | | | | | | |
| Appearance | Weld Line | 5 | 4 | 5 | 2 | 1 | 3 |
| | Flow Mark | 5 | 4 | 5 | 2 | 2 | 2 |
| | Pearly Luster | 5 | 5 | 5 | 2 | 2 | 2 |
| | Total Score | 15 | 13 | 15 | 6 | 5 | 7 |
| Heat | DTUL (1.8 MPa) | 67 | 59 | 92 | 61 | 52 | 86 |
| Resistance | | | | | | | |
| Mechanical | Tensile Strength | 51 | 62 | 57 | 49 | 60 | 54 |
| Properties | (MPa) | | | | | | |
| | Tensile Fracture | 12.0 | 9.5 | 24.5 | 3.5 | 3.4 | 4.5 |
| | Elongation (%) | | | | | | |
| | Charpy Impact | 9.5 | 4.5 | 28.0 | 3.6 | 1.9 | 7.5 |
| | Strength (kJ/m²) | | | | | | |

As can be seen from Table 3, when the resin molded articles (Example 9 and Comparative Example 6, Example 10 and Comparative Example 7, and Example 11 and Comparative Example 8) having the same composition ratio of the resin composition among Examples and Comparative Examples are compared to each other, the results are as follows. In the resin molded articles of Examples obtained from the resin composition containing the acrylic block copolymer, the impact resistance and tensile fracture elongation are improved and the appearance is better as compared to the resin molded article of Comparative Examples obtained from the resin composition containing PMMA. In addition, as can be seen from the results of Examples 1 to 11 and Comparative Example 5, in the resin molded article obtained from the resin composition containing a polylactic acid resin, an aromatic polycarbonate resin, a styrene-based polymer, the acrylic block copolymer, even if the content of the polylactic acid resin is more than 30% by weight with respect to 100 parts by weight of a total weight of a mixed resin of the polylactic acid resin, the aromatic polycarbonate resin, and the styrene-based polymer, the impact resistance and tensile fracture elongation are improved, and the appearance is better as compared to the resin molded article of Comparative Example 5 obtained from the mixed resin.

### Example 12

A predetermined resin molded article (test piece for evaluation) is obtained under the same conditions as Example 1, except that 50 parts by weight of polylactic acid resin, 40 parts by weight of aromatic polycarbonate resin, 10 parts by weight of acrylonitrile-butadiene-styrene resin, 1.5 parts by weight of Acrylic block copolymer A-1, and 1 part by weight of hydrolysis inhibitor are mixed.

### Example 13

A predetermined resin molded article (test piece for evaluation) is obtained under the same conditions as Example 1, except that 50 parts by weight of polylactic acid resin, 40 parts by weight of aromatic polycarbonate resin, 10 parts by weight of acrylonitrile-butadiene-styrene resin, 9 parts by weight of Acrylic block copolymer A-1, and 1 part by weight of hydrolysis inhibitor are mixed.

### Example 14

A predetermined resin molded article (test piece for evaluation) is obtained under the same conditions as Example 1, except that 50 parts by weight of polylactic acid resin, 40 parts by weight of aromatic polycarbonate resin, 10 parts by weight of acrylonitrile-butadiene-styrene resin, 1 part by weight of Acrylic block copolymer A-1, and 1 part by weight of hydrolysis inhibitor are mixed.

### Example 15

A predetermined resin molded article (test piece for evaluation) is obtained under the same conditions as Example 1, except that 50 parts by weight of polylactic acid resin, 40 parts by weight of aromatic polycarbonate resin, 10 parts by weight of acrylonitrile-butadiene-styrene resin, 10 parts by weight of Acrylic block copolymer A-1, and 1 part by weight of hydrolysis inhibitor are mixed.

### Example 16

A predetermined resin molded article (test piece for evaluation) is obtained under the same conditions as Example 1, except that 50 parts by weight of polylactic acid resin, 40 parts by weight of aromatic polycarbonate resin, 10 parts by weight of acrylonitrile-butadiene-styrene resin, 0.5 part by weight of Acrylic block copolymer A-1, and 1 part by weight of hydrolysis inhibitor are mixed.

### Example 17

A predetermined resin molded article (test piece for evaluation) is obtained under the same conditions as Example 1, except that 50 parts by weight of polylactic acid resin, 40 parts by weight of aromatic polycarbonate resin, 10 parts by weight of acrylonitrile-butadiene-styrene resin, 11 parts by weight of Acrylic block copolymer A-1, and 1 part by weight of hydrolysis inhibitor are mixed.

Using the obtained test pieces for evaluation, the same evaluation and test as Example 1 are performed. Table 4 collectively shows the compositions (all of which are represented by part(s) by weight) of the resin compositions of Examples 12 to 17 and the results of the above-described evaluation and test thereof.

TABLE 4

| | Composition | Example 12 | Example 13 | Example 14 | Example 15 | Example 16 | Example 17 |
|---|---|---|---|---|---|---|---|
| Composition | Polylactic Acid | 50 | 50 | 50 | 50 | 50 | 50 |
| | Resin | | | | | | |
| | Aromatic | 40 | 40 | 40 | 40 | 40 | 40 |
| | Polycarbonate | | | | | | |
| | Resin | | | | | | |
| | ABS Resin | 10 | 10 | 10 | 10 | 10 | 10 |
| | Acrylic Block | 1.5 | 9 | 1 | 10 | 0.5 | 11 |
| | Copolymer (A-1) | | | | | | |
| | Hydrolysis | 1 | 1 | 1 | 1 | 1 | 1 |
| | Inhibitor | | | | | | |
| Evaluation | | | | | | | |
| Result | | | | | | | |
| Appearance | Weld Line | 4 | 5 | 3 | 5 | 3 | 5 |
| | Flow Mark | 3 | 5 | 3 | 4 | 3 | 3 |
| | Pearly Luster | 3 | 5 | 3 | 5 | 2 | 4 |
| | Total Score | 10 | 15 | 9 | 14 | 8 | 12 |
| Heat | DTUL (1.8 MPa) | 63 | 62 | 62 | 61 | 60 | 60 |
| Resistance | | | | | | | |
| Mechanical | Tensile Strength | 50 | 50 | 48 | 49 | 47 | 48 |
| Properties | (MPa) | | | | | | |
| | Tensile Fracture | 8.5 | 13.2 | 6.8 | 12.3 | 4.6 | 10.8 |
| | Elongation (%) | | | | | | |
| | Charpy Impact | 4.5 | 12.0 | 3.5 | 10.8 | 3.2 | 9.6 |
| | Strength (kJ/m²) | | | | | | |

As can be seen from Table 4, in the resin molded articles of Examples 12 to 15 obtained from the resin composition in which the content of the acrylic block copolymer is from 1.0% by weight to 10% by weight with respect to 100 parts by weight of a total weight of the polylactic acid resin, the aromatic polycarbonate resin, and the styrene-based polymer, the appearance, heat resistance, and mechanical properties are improved as compared to the resin molded article of Example 16 obtained from the resin composition in which the content of the acrylic block copolymer is less than 1.0% by weight and the resin molded article of Example 17 obtained from the resin composition in which the content of the acrylic block copolymer is more than 10% by weight.

### Example 18

A predetermined resin molded article (test piece for evaluation) is obtained under the same conditions as Example 1, except that 3 parts by weight of Flame retardant A (trade name: “Nova Excell 140”, manufactured by Rin Kagaku Kogyo Co., Ltd., red phosphorus content: 92%, surface-treated product of phenol resin and Al(OH)₃) is added to the resin composition.

### Example 19

A predetermined resin molded article (test piece for evaluation) is obtained under the same conditions as Example 1, except that 20 parts by weight of Flame retardant B (trade name: “AP422”, manufactured by Clariant, phosphorus content: 30%, major component: ammonium polyphosphate) is added to the resin composition.

### Example 20

A predetermined resin molded article (test piece for evaluation) is obtained under the same conditions as Example 1, except that 20 parts by weight of Flame retardant C (trade name: “CR-741”, manufactured by Daihachi Chemical Industry Co., Ltd., phosphorus content: 9%, major component: aromatic condensed phosphoric ester) is added to the resin composition.

### Comparative Example 9

A predetermined resin molded article (test piece for evaluation) is obtained under the same conditions as Comparative Example 1, except that 3 parts by weight of Flame retardant A (trade name: “Nova Excell 140”, manufactured by Rin Kagaku Kogyo Co., Ltd., red phosphorus content: 92%, surface-treated product of phenol resin and Al(OH)₃) is added to the resin composition.

### Comparative Example 10

A predetermined resin molded article (test piece for evaluation) is obtained under the same conditions as Comparative Example 1, except that 20 parts by weight of Flame retardant B (trade name: “AP422”, manufactured by Clariant, phosphorus content: 30%, major component: ammonium polyphosphate) is added to the resin composition.

### Comparative Example 11

A predetermined resin molded article (test piece for evaluation) is obtained under the same conditions as Comparative Example 1, except that 20 parts by weight of Flame retardant C (trade name: “CR-741”, manufactured by Daihachi Chemical Industry Co., Ltd., phosphorus content: 9%, major component: aromatic condensed phosphoric ester) is added to the resin composition.

Using the obtained test pieces for evaluation, the following flame retardance test as well as the same evaluation and test as Example 1 are performed. Table 5 collectively shows the compositions (all of which are represented by part(s) by weight) of the resin compositions and the results of the above-described evaluation and test thereof.

### Flame Retardance Test

Using a UL test piece for a V test of UL-94, a UL-V test is performed using a method of UL-94. Criteria of the UL-V test are as follows.

V-0: Flame retardance is highest

V-1: Flame retardance is high but lower than V-0

V-2: Flame retardance is high but lower than V-1

not-V: Flame retardance is lower than V-2

TABLE 5

| | | | | | Comparative | Comparative | Comparative |
|---|---|---|---|---|---|---|---|
| | Composition | Example 18 | Example 19 | Example 20 | Example 9 | Example 10 | Example 11 |
| Composition | Polylactic Acid | 30 | 30 | 30 | 30 | 30 | 30 |
| | Resin | | | | | | |
| | Aromatic | 55 | 55 | 55 | 55 | 55 | 55 |
| | Polycarbonate | | | | | | |
| | Resin | | | | | | |
| | ABS Resin | 15 | 15 | 15 | 15 | 15 | 15 |
| | Acrylic Block | 5 | 5 | 5 | | | |
| | Copolymer (A-1) | | | | | | |
| | Comparative | | | | 5 | 5 | 5 |
| | Polymer (B-1) | | | | | | |
| | Flame Retardant A | 3 | | | 3 | | |
| | Flame Retardant B | | 20 | | | 20 | |
| | Flame Retardant C | | | 15 | | | 15 |
| | Hydrolysis | 1 | 1 | 1 | 1 | 1 | 1 |
| | Inhibitor | | | | | | |
| Evaluation | | | | | | | |
| Result | | | | | | | |
| Appearance | Weld Line | 5 | 5 | 4 | 3 | 3 | 2 |
| | Flow Mark | 5 | 4 | 4 | 2 | 3 | 3 |
| | Pearly Luster | 5 | 5 | 4 | 5 | 5 | 4 |
| | Total Score | 15 | 14 | 12 | 10 | 11 | 9 |
| Flame | UL-94/1.6 mm | V-0 | V-2 | V-2 | V-2 | not-V | not-V |
| Retardance | | | | | | | |
| Heat | DTUL (1.8 MPa) | 91 | 90 | 82 | 89 | 88 | 78 |
| Resistance | | | | | | | |
| Mechanical | Tensile Strength | 55 | 56 | 54 | 51 | 52 | 51 |
| Properties | (MPa) | | | | | | |
| | Tensile Fracture | 9.8 | 8.5 | 7.8 | 3.2 | 2.5 | 2.1 |
| | Elongation (%) | | | | | | |
| | Charpy Impact | 18.5 | 9.5 | 6.5 | 3.5 | 2.4 | 2.0 |
| | Strength (kJ/m²) | | | | | | |

As can be seen from Table 5, in the resin molded articles of Examples 18 to 20 obtained from the resin composition containing an aromatic polycarbonate, a styrene-based polymer, a polylactic acid resin, the acrylic block copolymer, and a phosphorus-based flame retardant, the impact resistance, tensile fracture elongation, and flame retardance are improved, and the appearance is better, as compared to the resin molded articles of Comparative Examples 9 to 11 obtained from the resin composition containing an aromatic polycarbonate, a styrene-based polymer, a polylactic acid resin, PMMA, and a phosphorus-based flame retardant.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition comprising:
an aromatic polycarbonate;
a styrene-based polymer;
a polylactic acid resin; and
an acrylic block copolymer that includes a polymer block containing a constitutional unit derived from an acrylic acid ester and a polymer block containing a constitutional unit derived from a methacrylic acid ester.

2. The resin composition according to claim 1,
wherein a content of the polymer block containing a constitutional unit derived from an acrylic acid ester in the acrylic block copolymer is from 30% by weight to 80% by weight.

3. The resin composition according to claim 1,
wherein the acrylic block copolymer is a triblock copolymer in which the polymer block containing a constitutional unit derived from a methacrylic acid ester is bonded to both terminals of the polymer block containing a constitutional unit derived from an acrylic acid ester.

4. The resin composition according to claim 2,
wherein the acrylic block copolymer is a triblock copolymer in which the polymer block containing a constitutional unit derived from a methacrylic acid ester is bonded to both terminals of the polymer block containing a constitutional unit derived from an acrylic acid ester.

5. The resin composition according to claim 1,
wherein a content of the acrylic block copolymer is from 1.0% by weight to 10% by weight with respect to 100 parts by weight of a total weight of the aromatic polycarbonate, the styrene-based polymer, and the polylactic acid resin.

6. The resin composition according to claim 2,
wherein a content of the acrylic block copolymer is from 1.0% by weight to 10% by weight with respect to 100 parts by weight of a total weight of the aromatic polycarbonate, the styrene-based polymer, and the polylactic acid resin.

7. The resin composition according to claim 3,
wherein a content of the acrylic block copolymer is from 1.0% by weight to 10% by weight with respect to 100 parts by weight of a total weight of the aromatic polycarbonate, the styrene-based polymer, and the polylactic acid resin.

8. The resin composition according to claim 4,
wherein a content of the acrylic block copolymer is from 1.0% by weight to 10% by weight with respect to 100 parts by weight of a total weight of the aromatic polycarbonate, the styrene-based polymer, and the polylactic acid resin.

9. A resin molded article comprising
the resin composition according to claim 1.

10. A resin molded article comprising
the resin composition according to claim 2.
